(19) United States
(12) Patent Application Publication
(10) Pub. No.: US 2016/0355909 A1
(43) Pub. Date: Dec. 8, 2016

(54) STAINLESS STEEL FOR A PLASTIC MOULD AND A MOULD MADE OF THE STAINLESS STEEL

(71) Applicant: UDDEHOLMS AB, Hagfors (SE)

(72) Inventors: Magnus TIDESTEN, Hagfors (SE); Lena RAHLEN, Uddeholm (SE)

(21) Appl. No.: 15/117,578

(22) PCT Filed: Feb. 9, 2015
(86) PCT No.: PCT/SE2015/050149

§ 371 Date: Aug. 9, 2016

(30) Foreign Application Priority Data
Feb. 18, 2014 (EP) 14155567.2

(51) Int. Cl. C22C 38/46; C22C 38/06; C22C 38/04; C21D 9/00; C22C 38/00; B29C 33/38; C21D 6/00; C21D 6/02; C22C 38/44; C22C 38/02

(52) U.S. Cl. CPC C22C 38/46; C22C 38/44; C22C 38/06; C22C 38/04; C22C 38/02; C22C 38/002; C22C 38/001; B29C 33/38; C21D 6/004; C21D 6/02; C21D 9/0068; B29K 2905/12; C21D 2211/001; C21D 2211/004

(57) ABSTRACT

The invention relates to a martensitic stainless steel for plastic forming moulds requiring a high hardness and a good corrosion resistance. The stainless steel consists of in weight % (wt. %): C 0.56-0.82, N 0.08-0.25, C+N 0.60-1.0, Si 1.05-2.0, Mn 0.2-1.0, Cr 12-16, Mo 0.1-0.8, V 0.10-0.45, Al≦0.3, P≦0.05, S≦0.5, optional elements, and balance Fe impurities.

### TECHNICAL FIELD

The invention relates to a martensitic stainless steel for plastic forming moulds requiring a high hardness and a good corrosion resistance. The invention is also directed to plastic forming moulds made of the inventive steel.

### BACKGROUND OF THE INVENTION

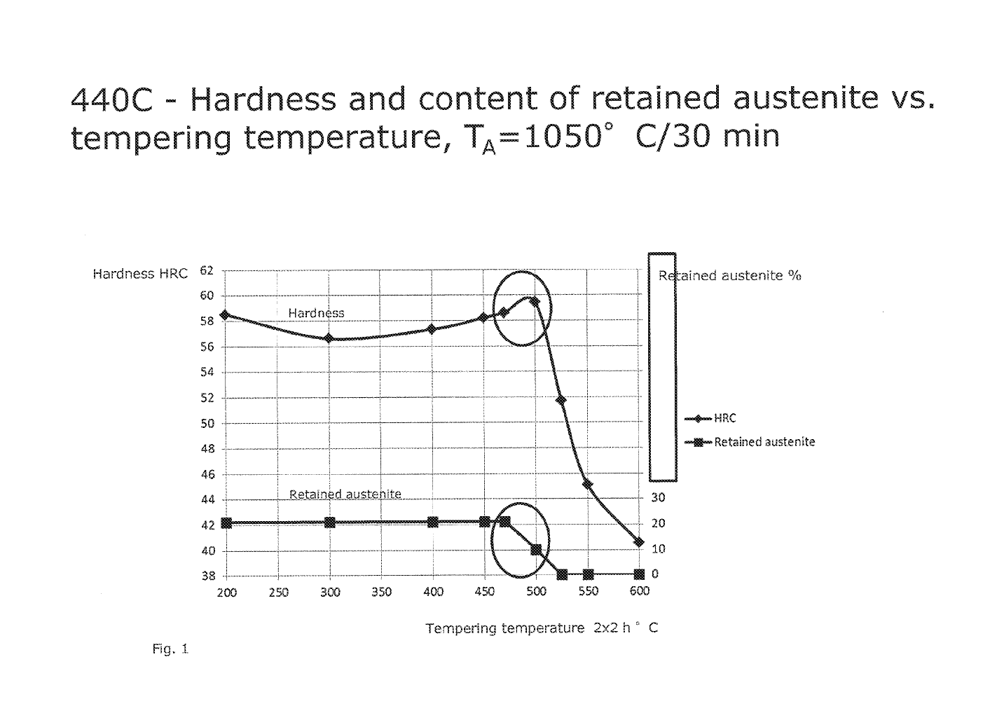

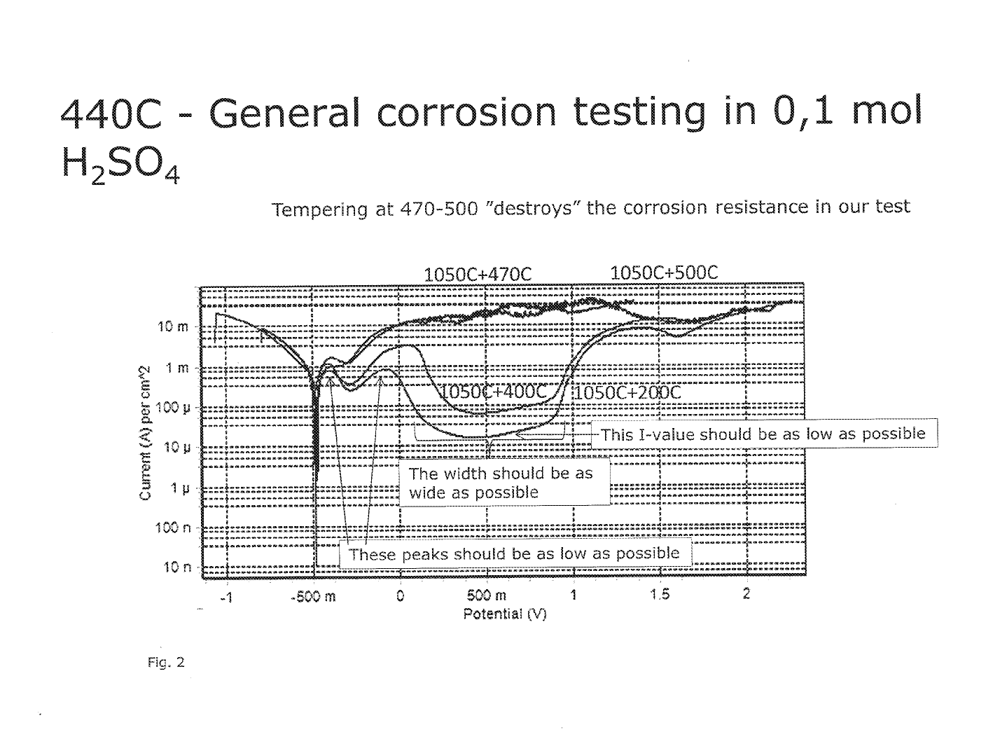

It is also known to use stainless steel, in particular pre-hardened 400 series stainless steel like AISI 420 and AISI 440 as material for plastic forming moulds. However, these steels are prone to carbide segregation and to the formation of delta ferrite. Substantial amounts of retained austenite may also be present in the hardened and tempered condition in these steels. The mechanical properties are therefore not optimal for plastic mould applications. The stainless steels having a medium carbon content of about 0.35 to 0.40 wt. % like steels of the type AISI 420, DIN 1.2316 and DIN 1.2085 suffer from a relatively low hardness, which results in a limited wear resistance. Stainless steels of the type AISI 440, such as AISI 440C, have a carbon content of about 1 wt. % and a good wear resistance. As shown in FIG. 1 this steel can obtain a hardness in the range of 58-60 HRC after tempering at low or high temperatures. However, as shown in FIG. 2, these steels suffer from a reduced corrosion resistance, in particular after annealing in the temperature range of 470-500 ° C. Low temperature annealing at 200° C. can be used in order to obtain a hardness of 58-60 HRC and an adequate corrosion resistance. However, a serious drawback of the low temperature annealing is that the steel will be prone to cracking. In particular, cracking will occur during Electro Discharge Machining (EDM) or even after grinding. Hence, when used for plastic moulds the steel AISI 440C needs to be subjected to high temperature annealing in order to prevent cracking but then the corrosion resistance is impaired.

In addition, to the above drawbacks the steel AISI 440C has a low dimensional stability at heat treatment due too high an amount of residual austenite.

### DISCLOSURE OF THE INVENTION

The general object of the present invention is to provide a stainless steel, which is suitable as a material for plastic forming moulds, which may be subjected to EDM. In particular, the stainless steel should be martensitic, have a high hardness and a good corrosion resistance even after high temperature annealing as well as a good dimensional stability.

Another object is to provide a plastic forming mould made from the new stainless steel.

The foregoing objects, as well as additional advantages are achieved to a significant measure by providing a stainless steel having a composition as set out in the alloy claims.

The steel has a property profile fulfilling the enhanced requirements for material properties raised by plastic mould makers.

The invention is defined in the claims.

### DETAILED DESCRIPTION

In the following the importance of the separate elements and their interaction with each other as well as the limitations of the chemical ingredients of the claimed alloy are briefly explained. Useful and preferred ranges are defined in the claims. All percentages of the chemical composition of the steel are given in weight % (wt. %) throughout the description.

Carbon (0.56-0.82%)

Carbon is favourable for the hardenability and is to be present in a minimum content of 0.56%, preferably at least 0.62%, 0.64% or 0.66%. At high carbon contents carbides of the type M₂₃C₆, M₇C₃ and M₂C, where M represents Cr, Fe, Mo, V or other carbide forming element, may be formed in the steel in a too high an amount leading to a reduced ductility and corrosion resistance. Moreover, a high carbon content may also lead to an increased amount of retained austenite. The carbon content shall therefore not exceed 0.82%. The upper limit for carbon may be set to 0.80%, 0.74%, 0.72% or 0.70%.

Nitrogen (0.08-0.25%)

Nitrogen is restricted to 0.08-0.25% in order to obtain the desired type and amount of hard phases, in particular V(C,N). When the nitrogen content is properly balanced against the vanadium content, vanadium rich carbo-nitrides V(C,N) will form. These will be partly dissolved during the austenitizing step and then precipitated during the tempering step as particles of nanometer size. The thermal stability of vanadium carbo-nitrides is considered to be better than that of vanadium carbides, hence the tempering resistance of the stainless tool steel may be improved. Further, by tempering at least twice, the tempering curve will have a higher secondary peak. However, excessive additions may lead to the formation of pores. Preferred ranges of N includes: 0.10-0.20%, 0.10-0.18%, 0.12-0.20% and 0.12-0.18% .

Silicon (1.05-2.0%)

Silicon is used for deoxidation. Si increases the activity of carbon in the steel. Si also improves the machinability of the steel. In order to get the desired effect the content of Si should be at least 1.05%, preferably higher such as 1.15% or 1.25%. However, Si is a strong ferrite former and should therefore be limited to <2.0%, preferably to 1.65%, 1.50% or 1.45%. In the present steel it would appear that silicon has a favourable effect on the tempering response in that the peak for the secondary hardening will occur at lower temperature and the hardness will be increased.

Manganese (0.2-1.0%)

Manganese contributes to improving the hardenability of the steel and together with sulphur manganese may contribute to improve the machinability by forming manganese sulphides. In addition, Mn increases the solubility of nitrogen in the steel. Manganese shall therefore be present in a minimum content of 0.2%, preferably at least 0.3%. However, Mn is introduced in the steel by scrap addition such that the lower limit may be set to 0.35% or 0.40% for cost reasons. Manganese is an austenite stabilizing element and should be limited to 1.0%, 0.8%, 0,65% or 0.60% in order to avoid too much residual austenite. Preferred ranges include 0.40-0.65% and 0.40-0.60%.

Chromium (12-16%)

Chromium is the most important element in stainless steels. When present in a dissolved amount of at least 12%, chromium results in the formation of a passive film on the steel surface. Chromium shall be present in the steel in an amount between 12 and 16% in order to give the steel a good hardenability and corrosion resistance. Preferably, Cr is present in an amount of more than 13% in order to safeguard a good pitting corrosion resistance. The lower limit is set in accordance to the intended application and may be 13.1%, 14.0%, 14.2% or 14.7%. However, Cr is a strong ferrite former and in order to avoid ferrite after hardening the amount need to be controlled. For practical reasons the upper limit may be reduced to 15.8%, 15.7%, 15.5% or 15.1%. Preferred ranges include 14.2-15.5% and 14.7-15.1%.

Molybdenum (0.1-0.8%)

Mo is known to have a very favourable effect on the hardenability. It is also known to improve the pitting corrosion resistance. In addition, Mo also promotes secondary hardening and the formation of M(C,N) more than W. The minimum content is 0.1%, and may be set to 0.17%, 0.23% 0.25% or 0.30%. Molybdenum is a strong carbide forming element and also a strong ferrite former. The maximum content of molybdenum is therefore 0.8%. Preferably Mo is limited to 0.7%, 0.65%, 0.55% or even 0.50%.

Vanadium (0.10-0.45%)

Vanadium forms evenly distributed primary precipitated carbonitrides of the type M(C,N) in the matrix of the steel. In the present steels M is mainly vanadium but significant amounts of Cr and some Mo may be present. Vanadium shall therefore be present in an amount of 0.10-0.45%. The upper limit may be set to 0.40%, 0.35% or 0.30%. The lower limit may be set to 0.15%, 0.20%, 0.22% or 0.25% .The upper and lower limits may be freely combined within the limits set out in claim 1.

Aluminium (≦0.3%)

Aluminium may be used for deoxidation. In most cases the aluminium content is limited to 0.06%. Suitable upper limits are 0.06%, 0.046%, 0.036% and 0.03%. Suitable lower limits set to ensure a sufficient deoxidation are 0.005% and 0.01%.

Optional Elements

Nickel (≦1%)

Nickel gives the steel a good hardenability and toughness. Because of the expense, the nickel content of the steel should be limited. A preferred content is ≦0.5% or ≦0.35%. Most preferably, Ni is not deliberately added.

Copper (≦3%)

Cu is an optional element, which may contribute to increasing the hardness and the corrosion resistance of the steel. In addition, it contributes to the corrosion resistance of the steel as well as to the machinability. If used, preferred ranges are 0.02-2% and 0.02-0.5%. However, it is not possible to extract copper from the steel once it has been added. This drastically makes the scrap handling more difficult. For this reason, copper is normally not deliberately added.

Cobalt (≦3%)

Co is an optional element. It contributes to increase the hardness of the martensite. The maximum amount is 3%. However, for practical reasons such as scrap handling there is no deliberate addition of Co. A preferred maximum content may be set to 0.15%.

Tungsten (≦0.8%)

Tungsten may be present at contents of up to 0.8% without being too detrimental to the properties of the steel. However, tungsten tends to segregate during solidification and may give rise to undesired delta ferrite. In addition, tungsten is expensive and it also complicates the handling of scrap. The maximum amount is therefore limited to 0.8%, preferably 0.5%, preferably no deliberate additions are made.

Niobium (≦0.1%)

Niobium is similar to vanadium in that it forms carbonitrides of the type M(C,N). The maximum addition of Nb is 0.1%. Preferably, no niobium is added.

Phosphorus (≦0.05%)

P is an impurity element, which may cause temper brittleness. It is therefore limited to ≦0.05%, 0.03%, 0.020%, 0.01% or 0.005%.

Sulphur (≦0.5%)

Sulphur is preferably limited to S≦0.004% in order to reduce the number of inclusions. However, S contributes to improving the machinability of the steel. A suitable content for improving the machinability of the steel in the hardened and tempered condition is 0.07-0.15%. At high sulphur contents there is a risk of red brittleness. Moreover, a high sulphur content may have a negative effect on the fatigue properties of the steel. The steel shall therefore contain ≦0.5%. However, if the steel is produced by Electro Slag Remelting (ESR) then the sulphur content should be very low, preferably ≦0.002%, more preferably <0.001% or ≦0.0008%.

Oxygen (optionally 0.003-0.01%)

Oxygen may be deliberately added to the steel during ladle treatment in order to form a desired amount of oxide inclusions in the steel and thereby improve the machinability of the steel. The oxygen content is then controlled to fall in the range of 0.003-0.01%. A preferred range is 0.003-0.007%. However, if the steel is produced by Electro Slag Remelting (ESR) then the oxygen content may be reduced to ≦0.001%, preferably ≦0.0008%.

Calcium (optionally 0.0003-0.009%)

Calcium may be deliberately added to the steel during ladle treatment in order to form inclusions of a desired composition and shape. Calcium is then added in amounts of 0.0003-0.009, preferably 0.0005-0.005.

Be, Se, Mg and REM (Rare Earth Metals)

These elements may be added to the steel in the claimed amounts in order to further improve the machinability, hot workability and/or weldability.

Boron 0.01%)

B may be used in order to further increase the hardness of the steel. The amount is limited to 0.01%, preferably ≦0.003%.

Ti, Zr and Ta

These elements are carbide formers and may be present in the alloy in the claimed ranges for altering the composition of the hard phases. However, normally none of these elements are added.

PRE

The pitting resistance equivalent (PRE) is often used to quantify pitting corrosion resistance of stainless steels. A higher value indicates a higher resistance to pitting corrosion. For high nitrogen martensitic stainless steels the following expression may be used:

PRE=% Cr+3.3% Mo+30% N

wherein % Cr, % Mo and % N are the contents dissolved in the matrix at the austenitizing temperature (T_{A}). The dissolved contents can be calculated with Thermo-Calc for the actual austenitizing temperature (T_{A}) and/or measured in the steel after quenching.

The austenitizing temperature (T_{A}) is in the range of 950-1200° C., typically 1000-1050° C. Preferably, the PRE-number is in the range of 16-18.

Steel Production

A stainless steel having the claimed chemical composition can be produced by conventional steel making or by powder metallurgy (PM). This type of steel is often made by melting scrap in an Electric Arc Furnace (EAF) then subjecting the steel to ladle metallurgy and, optionally, a vacuum degassing. The oxygen content may be increased in the liquid steel in the ladle by stirring the melt and exposing the melt surface to the atmosphere and/or by the addition of mill scale. Calcium may be added at the end of the metallurgical treatment, preferably as CaSi. However, this treatment is optional and it is only performed if there are special requirements on the machinability of the steel.

The melt is cast to ingots by ingot casting, suitably bottom casting. Powder metallurgical (PM) manufacture may be used but is normally not used for cost reasons. On the other hand, steels for plastic moulds often requires a high cleanliness. For this reason one or more remelting steps such as VIM, VAR or ESR may be included in the processing route. In most cases ESR is the preferred route.

The steel can be heat treated to adjust the hardness in a similar way as used for type 400 series stainless steel. The hardening temperature range is preferably in the range of 980° C.-1030° C. because exceeding 1030° C. will give grain growth and increased retained austenite content.

The holding time should be about 30 minutes. A temperature of 1020° C. is preferred

The steel should be tempered two times with intermediate cooling to room temperature. The holding time at the tempering temperature should be minimum 2 hours. The lowest tempering temperature that should be used is 250° C.

When using 1020° C. as hardening temperature a hardness of 56-58 HRC can be reached after tempering at 250° C. A hardness of 58-60 HRC can be reached after tempering at 520° C. The latter treatment removes retained austenite and gives dimensional changes close to zero.

### Example

A steel composition according to the invention was prepared by conventional metallurgy. The comparative steel was a standard AISI 440C. The compositions of the examined steels are given in Table 1 (in wt. %) balance Fe apart from impurities.

TABLE 1
Compositions of the examined steels.

| | Inventive | Comparativ steel |
|---|---|---|
| Element | steel | AISI 440 C |
| C | 0.68 | 1.05 |
| Si | 1.35 | 0.42 |
| Mn | 0.53 | 0.43 |
| Cr | 14.9 | 16.6 |
| Ni | 0.14 | 0.29 |
| Mo | 0.43 | 0.49 |
| V | 0.29 | 0.06 |
| Al | 0.016 | 0.014 |
| N | 0.16 | 0.051 |

The inventive steel was subjected to hardening by austenitzing at 1000-1050 ° C. for 30 minutes and tempered twice for two hours at 400-550 ° C. The results are shown in Table 2.

TABLE 2
Hardening results of the inventive steel

| Hardening | Tempering | Hardness | Retained austenite |
|---|---|---|---|
| Temp. ° C. | Temp. ° C. | HRC | vol. % |
| 1050 | 450 | 58.3 | 11 |
| 1050 | 500 | 60.1 | 13 |
| 1030 | 450 | 59.1 | 20 |
| 1030 | 500 | 59.0 | 0 |
| 1000 | 450 | 58.1 | 11 |
| 1000 | 480 | 58.7 | 7 |

The comparative steel was also subjected to hardening and tempering and the result is shown in Table 3.

TABLE 3
Hardening results of the comparative steel AISI 440C

| Hardening | Tempering | Hardness | Retained austenite |
|---|---|---|---|
| Temp. ° C. | Temp. ° C. | HRC | vol. % |
| 1050 | 450 | 58.0 | 21 |
| 1050 | 500 | 59.2 | 10 |
| 1050 | 525 | 51.6 | 0 |
| 1050 | 550 | 45.1 | 0 |

It can be seen that the required hardness can be achieved by the comparative steel after tempering at 450° C. and 500° C. but the amount of retained austenite is far too high to secure a good dimensional stability. As a rule of thumb the amount of retained austenite should be less than 8% during hardening and in production in order to obtain a good dimensional stability. Although higher tempering temperatures can be used to reduce the amount of retained austenite they are not an option since hardness will be far too low.

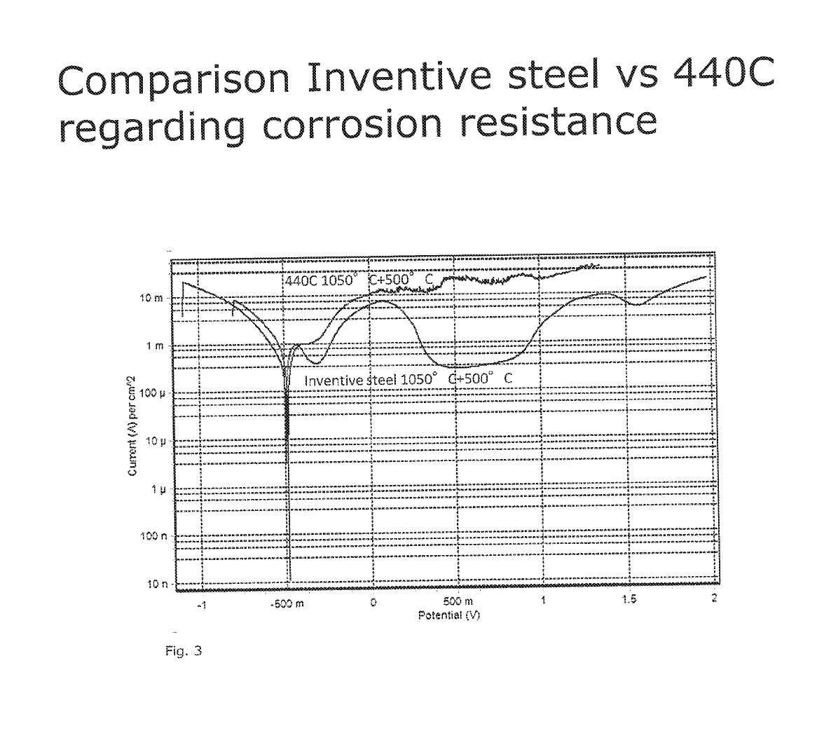

The corrosion resistance of the inventive steel was found to be superior to the comparative steel AISI 440C in all tests. The tests were performed in 0.1 mol H₂SO₄ at room temperature. The results of one comparative test shown in FIG. 3 reveals that the inventive steel had a significant better corrosion resistance than AISI 440C after tempering at 500° C.

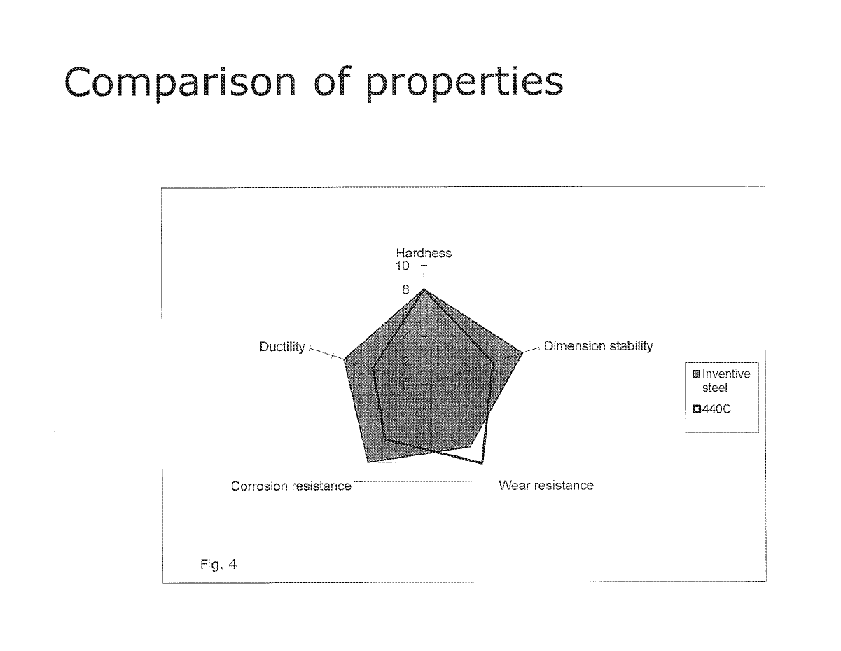

Additional tests were performed in order to compare other properties of the inventive steel with the reference steel. The results are summarized in FIG. 4 and it can be seen that the inventive steel has an improved property profile for the intended use in plastic forming moulds.

Although the steel alloy is specially developed for use in plastic forming moulds it is believed that the alloy may be useful in many other applications. Conceivable applications include but are not limited to knives, in particular knives, screws, chopper discs and press rollers in areas where corrosion resistance is required such as in the food processing industry and the plastic recycling industry. The steel may be provided in any conventional form including rods and strips.

1. A stainless steel for a plastic mould consisting of in weight % (wt. %):
C 0.56-0.82
N 0.08-0.25
C+N 0.64-1.0
Si 1.05-2.0
Mn 0.2-1.0
Cr 12-16
Mo 0.1-0.8
V 0.10-0.45
Al≦0.3
P≦0.05
S≦0.5
optionally
Ni≦1
Cu≦3
Co≦3
W≦0.8
Nb≦0.1
Ti≦0.1
Zr≦0.1
Ta≦0.1
B≦0.01
Be≦0.2
Se≦0.3
Ca0.0003-0.009
O 003-0.01
Mg≦0.01
REM≦0.2
balance Fe apart from impurities.

2. A stainless steel for a plastic mould according to claim 1 fulfilling at least one of the following requirements (in wt. %):
C 0.56-0.80
N 0.10-0.20
C+N 0.66-0.90
Si 1.05-1.65
Mn 0.3-0.8
Cr 13.1-15.8
Mo 0.2-0.7
V 0.15-0.40
Al≦0.06
Ni≦0.5
Cu0.02-2
Co<0.5
W≦0.5
Nb≦0.008
Ti≦0.01
Zr≦0.01
Ta≦0.01
B≦0.003
P≦0.03
S≦0.002
O≦0.001

3. A stainless steel for a plastic mould according to claim 1 fulfilling at least one of the following requirements (in wt. %):
C 0.62-0.74
N 0.10-0.18
(C+N) 0.72-0.88
Si 1.05-1.50
Mn 0.35-0.55
Cr 14.0-15.7
Mo 0.23-0.65
V 0.22-0.35
Al 0.005-0.046
Cu≦0.5
Ti≦0.005
Nb≦0.005
P≦0.020
S≦0.004
Ni≦0.3

4. A stainless steel for a plastic mould according claim 1 fulfilling at least one of the following requirements (in wt. %):
C 0.64-0.72
N 0.12-0.20
(C+N) 0.76-0.84
Si 1.15-1.65
Mn 0.40-0.65
Cr 14.2-15.5
Mo 0.25-0.55
V 0.20-0.28
Al0.01-0.036

5. A stainless steel for a plastic mould according to claim 1 fulfilling at least one of the following requirements (in wt. %):
C 0.66-0.70
N 0.12-0.18
Si 1.25-1.45
Mn 0.40-0.60
Cr 14.7-15.1
Mo 0.30-0.50
V 0.25-0.30
Al≦0.03

6. A stainless steel for a plastic mould according to claim 1 fulfilling the following requirements (in wt. %):
C 0.66-0.70
N 0.12-0.18
Si 1.25-1.45
Mn 0.40-0.60
Cr 14.7-15.1
Mo 0.30-0.50
V 0.25-0.30

7. A stainless steel for a plastic mould according to claim 1 fulfilling at least one of the following requirements (in wt. %):
Ni≦0.35
Cu≦0.15
Co≦0.15
W≦0.15
P≦0.01
S≦0.001
O≦0.001

8. A stainless steel for a plastic mould according to claim 1 fulfilling the following requirements (in wt. %):
P≦0.005
S≦0.0008
O≦0.0008

9. A stainless steel for a plastic mould according to claim 1, wherein the steel fulfils the following requirements (in wt. %):
C 0.66-0.70
N 0.12-0.18
Si 1.25-1.45
Mn 0.40-0.60
Cr 14.7-15.1
Mo 0.30-0.50
V 0.25-0.30
Ni≦0.35
Cu≦0.15
Co≦0.15
W≦0.15
P≦0.01
S≦0.001
O≦0.001

10. A stainless steel for a plastic mould according to claim 1, wherein the steel fulfils at least one of the following conditions:
i) retained austenite≦8 volume %
ii) hardness 56-62 HRC

11. A stainless steel for a plastic mould according to claim 1, wherein the steel fulfils at least one of the following conditions:
i) retained austenite≦5 volume %
ii) hardness 58-60 HRC

12. A stainless steel for a plastic mould according to claim 1, wherein the steel is not produced by powder metallurgy.

13. A stainless steel for a plastic mould according to claim 1, wherein the steel has an unnotched impact energy of more than 40 J, preferably more than 50 J, in the TL-direction at 58 HRC.

14. A stainless steel for a plastic mould according to claim 1, wherein the dimensional changes during hardening and tempering are less than 0.15%.

15. A plastic mould made of a steel as defined in claim 1.

16. A stainless steel for a plastic mould according to claim 9, wherein the steel fulfils the following requirements (in wt. %):
P≦0.005
S≦0.0008
O≦0.0008

17. A stainless steel for a plastic mould according to claim 14, wherein the dimensional changes during hardening and tempering are less than 0.1%.

18. stainless steel for a plastic mould according to claim 17, wherein the dimensional changes during hardening and tempering are less than 0.05%.
